(19) United States
(12) Patent Application Publication
(10) Pub. No.: US 2014/0317100 A1
(43) Pub. Date: Oct. 23, 2014

(54) REAL-TIME BIOMETRIC DATABASE AND TEMPLATE MANAGEMENT

(71) Applicant: IMAGEWARE SYSTEMS, INC., San Diego, CA (US)

(72) Inventor: David Harding, Clackamas, OR (US)

(21) Appl. No.: 14/254,472

(22) Filed: Apr. 16, 2014

Related U.S. Application Data
(60) Provisional application No. 61/812,551, filed on Apr. 16, 2013.

(51) Int. Cl. G06F 17/30

(52) U.S. Cl. CPC G06F 17/30424
USPC 707/723; 707/779

(57) ABSTRACT

The present disclosure may describe systems and methods for allowing real-time biometric matching. A real-time biometric system may include elements such as one or more biometric clients, a cloud network, a query router, an IP network, and one or more query engines associated with corresponding template data caches. During a biometric matching process, a template data manager (TDM) integrated in query engine may use memory maps for real-time retrieval and comparison of biometric templates. The comparison process may generate a biometric score that may be returned to biometric client indicating a successful or fail match. In addition, template data caches may include indexes with non-biometric metadata to filter associated biometric templates during a biometric matching process. TDM may operate with a plug-in architecture for allowing integration of different modalities of biometric algorithms.

### CROSS-REFERENCE TO RELATED APPLICATION

The present application claims priority to U.S. Provisional Patent Application No. 61/812,551, filed on Apr. 16, 2013, and entitled “Real-Time Biometric Database and Template Management,” the disclosure of which is herein incorporated by reference in its entirety.

### BACKGROUND OF THE INVENTION

1. Field of Invention

The present disclosure relates in general to biometrics and biometric systems. In particular, the present invention relates to methods and systems for biometric matching in a real-time biometric database.

2. Description of Related Art

A biometric template is a digital reference of distinct characteristics or salient features that have been extracted from biometric raw data, e.g., image of a fingerprint, a face or an iris, or a sound from a microphone. Generally, templates contain information necessary for biometric verification, i.e., authentication, or identification, i.e., matching. Biometric templates are typically stored and managed via a relational database management system (RDMS) using structured query language (SQL) as the database query language. Examples of RDMS are SQL Server, Oracle Database, Sybase, MySQL and PostgreSQL, the implementations of which are all apparent to one of ordinary skill in the art. However, use of SQL databases for storing, managing and matching biometrics templates are non-efficient, especially when dealing with a large volume of biometric templates such as automated fingerprint identification systems having hundreds of millions of fingerprints.

During a biometric matching process, an SQL database in a biometric system accepts a query request from a biometric client, where the request is processed in a server. This produces an execution strategy, such as indexing. Subsequently, a temporary table is created to store the query result. Then, biometric templates are queried from each table requested in the query and copied in the temporary table space. Afterwards, copies of biometric templates are returned to the biometric client, which generates another copy of biometric templates for matching.

The above described biometric matching process using an SQL database includes significant processing delays when performing biometric analysis and matching requests. That is, the repetitive copy of data in temporary tables and the biometric client incurs substantial processing times and also forces the use of a network protocol, which delays the biometric matching process even further. Moreover, when original biometric templates are duplicated and manipulated out of the server/database, biometric templates can be exposed to alteration or theft.

### SUMMARY OF THE INVENTION

The present invention overcomes these and other deficiencies of the prior art by providing a template data manager for use in a biometric system comprising one or more biometric clients in communication with a query router through a suitable cloud or internet network. The query router is operably coupled with one or more query engines, each of these query engines integrating the template data manager, which manages the searching and matching of biometric templates stored in one or more template data caches.

During biometric matching, a biometric client provides one or more biometric probes to the query router, which distributes these biometric probes to corresponding query engines depending on the workload of the query engine and the biometric modality. A query engine in conjunction with its template data manager converts the biometric probes into corresponding biometric templates for comparison against previously stored biometric templates in one or more template data caches. The template data manager uses one or more memory maps to read one or more biometric templates in primary memory corresponding to one or more biometric templates stored in the template data cache. Primary memory refers to the main memory in a computer in which data is stored for quick access by the computer's processor. Random access memory (RAM) is an example of primary memory (and in contrast to secondary memory such as a hard drive.). Each memory map includes a plurality of biometric templates at any given time, with corresponding primary memory addresses associated with the biometric templates. By using memory maps and storing templates in primary memory, the template data manager can search and compare biometric templates in real-time, in memory directly and accessible to a processor, instead of accessing them from the template data caches on disk. This biometric template comparison process generates a biometric score the represents a probability of successful matching.

The query engines in the real-time biometric system can operate in a plug-in architecture where biometric algorithms of different modality are wrapped around a corresponding plug-in. The biometric algorithms convert the biometric probes into biometric templates for matching, while the plug-ins function as a common interface to allow operation between the template data manager and the different modalities of biometric algorithms.

The biometric matching process may also include an indexing operation, where this indexing operation uses non-biometric metadata for filtering the search and comparison of biometric templates in the real-time biometric system. These indexes using non-biometric metadata are included in the template data caches or can be in the form of a separate file associated with the memory maps for efficient retrieval and comparison of biometric templates.

In an embodiment of the invention, a biometric system comprises: a first query engine, the first query engine comprising a template data manager; a first template data cache in communication with the first query engine, the first template data cache storing a set of biometric templates; primary memory; wherein the template data manager copies a subset of the set of biometric templates into the primary memory for comparison against a biometric probe template. The first query engine converts a received biometric probe into the biometric probe template. The system may further comprise a second query engine, the second query engine comprising a template data manager; a second template data cache in communication with the second query engine; and a query router for routing the biometric probe to the first query engine. The memory map identifies primary memory addresses of the subset of biometric templates. The primary memory is selected from the group consisting of: random access memory, a processor cache, read only memory, and a combination thereof. The first query engine comprises a biometric algorithm, wherein the biometric algorithm converts a biometric probe into a biometric probe template, and a plug-in interface. The first query engine is configured to compare the subset of biometric templates in primary memory against a biometric probe template and generate a biometric score for each of the subset of biometric templates.

In another embodiment of the invention, a biometric processing system comprises: primary memory comprising a set of biometric templates; a memory map identifying primary memory addresses of the set of biometric templates; and a template data manager configured to search and compare the set of biometric templates against a biometric probe. The primary memory comprises random access memory. Alternatively, the primary memory comprises a processor cache or read only memory.

In yet another embodiment of the invention, a biometric matching method implemented on a processor comprises the steps of: copying a set of biometric templates into primary memory from a template data cache; creating a memory map, wherein the memory map identifies primary memory addresses of the set of biometric templates; and comparing a biometric probe template against the set of biometric templates. The method may further comprise the steps of receiving a biometric probe, and converting the biometric probe into the biometric probe template. The method generates a biometric score for each biometric template in the set of biometric templates and identifying one or more matching biometric templates in the set of biometric templates. Additionally, the method can include the step of indexing biometric templates stored in the template data cache according to non-biometric metadata and identifying the set of biometric templates based on non-biometric data. The primary memory is selected from the group consisting of: random access memory, a processor cache, read only memory, and a combination thereof.

An advantage of the present invention is that it enhances efficiency and security of a biometric management and matching system. Efficiency is improved as the searching and comparison of biometric templates occurs in random access memory (RAM) and without requiring the copy of data from disk or hard drives to perform biometric matching. In addition, security is enhanced as biometric templates may not be exposed as they may remain in template data caches during biometric matching.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 illustrates a real-time biometric system according to an embodiment of the invention;

FIG. 2 illustrates a plug-in architecture of the query engine of FIG. 1 according to an embodiment of the invention;

FIG. 3 illustrates a memory map system facilitating real-time retrieval and comparison of biometric templates according to an exemplary embodiment of the invention;

FIG. 4 illustrates a biometric matching process using the real-time biometric system of FIG. 1 according to an embodiment of the invention;

FIG. 5 illustrates a non-biometric metadata implementation of the real-time biometric system of FIG. 1 according to an embodiment of the invention; and

FIG. 6 illustrates a biometric matching process using the non-biometric metadata implementation of FIG. 1 according to an embodiment of the invention.

### DETAILED DESCRIPTION OF EMBODIMENTS

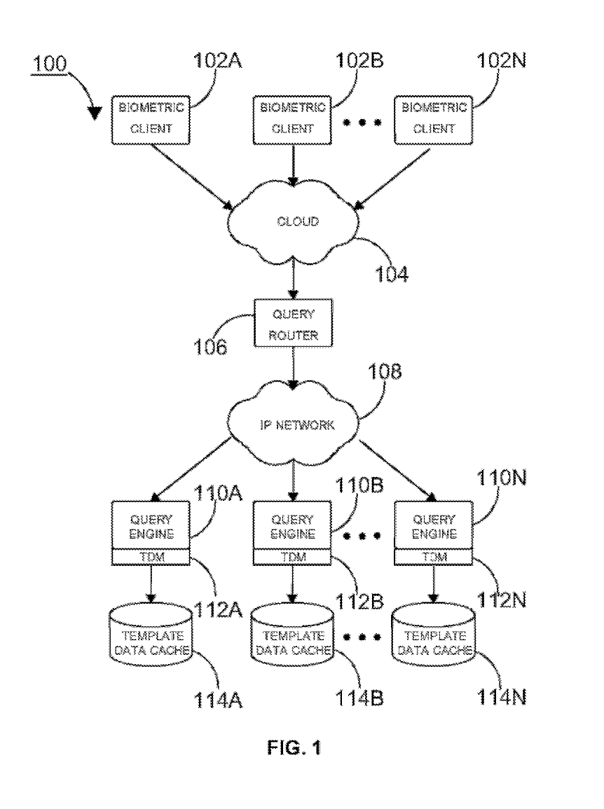

Preferred embodiments of the present invention and their advantages may be understood by referring to FIGS. 1-6, wherein like reference numerals refer to like elements. The descriptions and features disclosed herein can be applied to various interactive messaging systems, the identification and implementation of which are apparent to one of ordinary skill in the art. The features described herein are broadly applicable to any type of communications technologies and standards.

As used herein, the following terms have the following definitions:

“Biometric probe” refers to any captured biometric that is used to compare with or match against one or more prior biometric enrollments.

“Biometric template” is a piece of binary data generated by a biometric algorithm that is used to compare one biometric against another (e.g., a biometric probe template against a biometric template).

“Metadata” refers to non-biometric data associated with each of the plurality of biometric templates stored in a template data cache. Metadata can be used to filter biometric templates that match at least one non-biometric data.

“Query engine” refers to a system capable of, among other things, comparing biometric templates and returning a biometric score or a biometric fusion score, which is a multi-modal biometric score having been combined (i.e., fused) from a plurality of biometric modalities.

“Query router” refers to a device or system that may manage and queue queries in a query engine.

“Biometric score” refers to a probability score that a given biometric template and a given biometric probe template represent the same identity.

“Memory maps” refer to a block of biometric templates stored in primary or main memory, e.g., random access memory (RAM) or any memory directly accessible to a central processing unit, at a given time that through queries may allow real-time retrieval and comparison of biometric templates. RAM can be accessed hundreds of times faster than a hard drive.

FIG. 1 illustrates a real-time biometric system 100 according to an embodiment of the invention. Real-time biometric system 100 comprises one or more biometric clients 102A-N, a network 104, a query router 106, a network 108, and one or more query engines 110A-N associated with corresponding template data caches 114A-N. The networks 104 and 108 can be any types of telecommunications network (whether the same or different) such as, but not including the Internet or a private network (or any combination thereof) that allows the biometric clients 102A-N and query engines 110A-N to exchange data with the query router 106. Identification and implementation of networks 104 and 108 are readily apparent to one of ordinary skill in the art.

The biometric clients 102A-N include computing devices having installed thereon a suitable operating system and a biometric capturing device, the identification and implementation of which are apparent to one of ordinary skill in the art. The biometric clients 102A-N capture one or more biometric probes that are employed for identity authentication in the real-time biometric system 100.

The biometric clients 102A-N are in communication with the query router 106 via the network 104, which can be accessed through any type of communications protocol such as, but not limited to cellular 3G, cellular 4G, Wi-Fi, WiMax, or landline broadband, among others, the implementation of which are readily apparent to one of ordinary skill in the art. The query router 106 comprises a computer having installed thereon a suitable operating system and biometric software programmed according to the embodiments described herein.

Each query engine 110A-N includes at least one computing device, such as for example a desktop computer, server, or array of computers, each computing device having disk storage, memory, and processing capabilities, the implementation of all of which are apparent to one of ordinary skill in the art. Each query engine 110A-N includes a respective template data manager software module, herein referred as TDM 112A-N, which manages template data caches 114 where biometric templates are stored and retrieved. Optionally, TDM 112A-N operate as a separate module of query engines 110A-N. TDM 112A-N also manage multiple threads to support multiple simultaneous searches and enrollments.

In an embodiment of the invention, each query engine 110A-N is associated with one or more template data caches 114, which can be allocated in disk or memory of query engine 110. Each template data cache 114 is operable to store a plurality of biometric templates and associated with a specific type of biometric modality such as fingerprint, iris, or face, among others. In addition, one or more memory maps (not shown) are created in primary memory of query engine 110. A memory map includes a plurality of biometric templates at any given time, with corresponding primary memory addresses associated with biometric templates copied from template data caches 114.

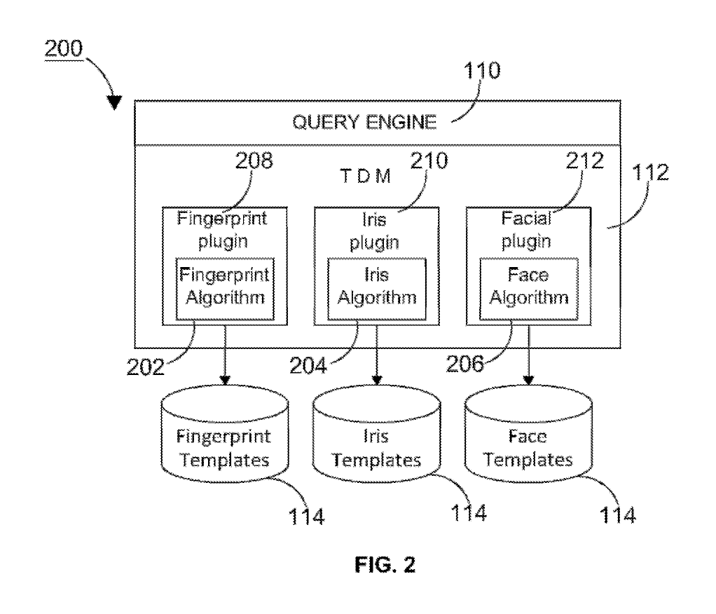

FIG. 2 illustrates a plug-in architecture 200 of the query engine 110 according to an embodiment of the invention. The plug-in architecture 200 comprises any number and types of biometric algorithms wrapped around corresponding plug-ins. In an exemplary embodiment of the invention, the plug-in architecture 200 may include a fingerprint algorithm 202, an iris algorithm 204, and a face algorithm 206. These biometric algorithms can be proprietary or custom made algorithms, and/or implemented in the form of software development kits (SDKs) provided by third parties. For example, the fingerprint algorithm 202 can be a fingerprint recognition SDK application provided by a vendor such as IDENTIX. The fingerprint algorithm 202 is configured to compare fingerprint biometric templates and return a score that represents the degree of similarity of the templates. Similarly, the iris algorithm 204 may be a SDK iris recognition application provided by a vendor such as IRIDIAN™. The iris algorithm 204 is configured to compare iris biometric templates and return a score that represents the degree of similarity of the templates. The face algorithm 206 may be a SDK recognition application provided by a vendor such as COGNITEC™. The query engine 110 may include any combination of one or more separate biometric algorithms or SDKs.

As shown, the fingerprint algorithm 202, the iris algorithm 204 and the face algorithm 206 are wrapped in a plugin. That is, the fingerprint algorithm 202 is wrapped in a fingerprint plugin 208, the iris algorithm 204 is wrapped in an iris plugin 210, and the face algorithm 206 is wrapped in a face plugin 212. Each plugin, fingerprint plugin 208, iris plugin 210 and face plugin 212, may be a module that adheres to a common interface that allows TDM 112 to operate with the biometric algorithm in which the plugin is wrapped. Because a plugin has a common interface, it can be connected to query engine 110 with extremely minor setup and without query engine 110 having much knowledge about which third party SDK is being wrapped. The fingerprint plugin 208, the iris plugin 210, and the face plugin 212 enable the TDM 112 to supply biometric probes to their associated biometric algorithms for conversion and comparison. The TDM 112 also uses these plugins in conjunction with memory maps to quickly access enrolled biometric templates from their corresponding template data caches 114 and supply them to their associated biometric algorithms for comparison and scoring. The fingerprint plugin 208, the iris plugin 210, and the face plugin 212 further enable query engine 110 to receive scores from their associated biometric algorithm for transmission to the query router 106.

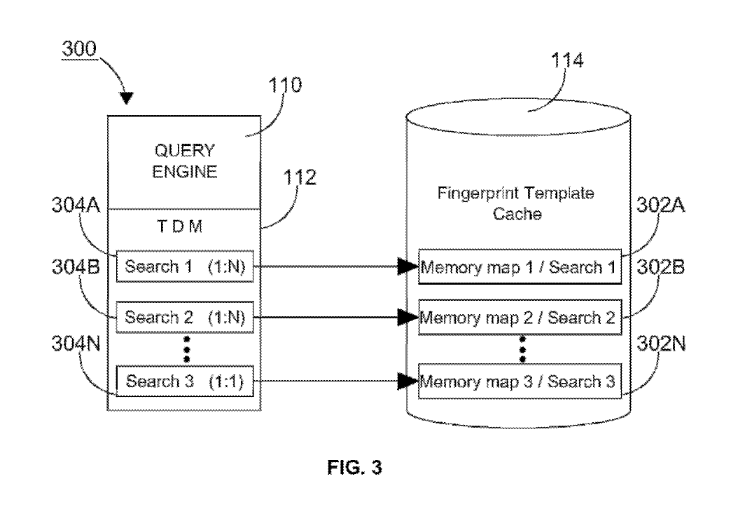

FIG. 3 illustrates a memory map system 300 facilitating real-time retrieval and comparison of biometric templates in a query engine 110 according to an exemplary embodiment of the invention. Here, one or more memory maps 302A-N correspond to one or more searches 304 to be processed by a TDM 112 in a query engine 110 at any given time. The memory maps 302A-N correspond to a block of data or group of biometric templates copied in from the template data cache 114 (and stored in primary memory such as, but not limited to random access memory (RAM)) and include primary memory addresses for each of the plurality of biometric templates. In an embodiment of the invention, the template data cache 114 contains only one modality of biometric templates such as fingerprint, iris, or face, among others.

Each TDM 112 support any number of searches 304A-N and employ multiple memory maps 302A-N to effectively maintain a plurality of biometric templates in primary memory, thus increasing query performance. For example, in a 1:N search, a memory map 302 moves linearly across template data cache 114 and reads all biometric templates stored in template data cache 114 before biometric templates are processed by the TDM 112. In a 1:1 search, a memory map 302 directly reads the biometric template associated with the query before biometric template reaches the TDM 112 for processing. The TDM 112 then compares biometric templates in memory maps 302A-N instead of having to access them directly from disk or template data cache 114.

The memory maps 302 used by the TDM 112 can be configured according to the type of and amount of the searches 304, processing power of the query engine 110, and the speed of biometric algorithms.

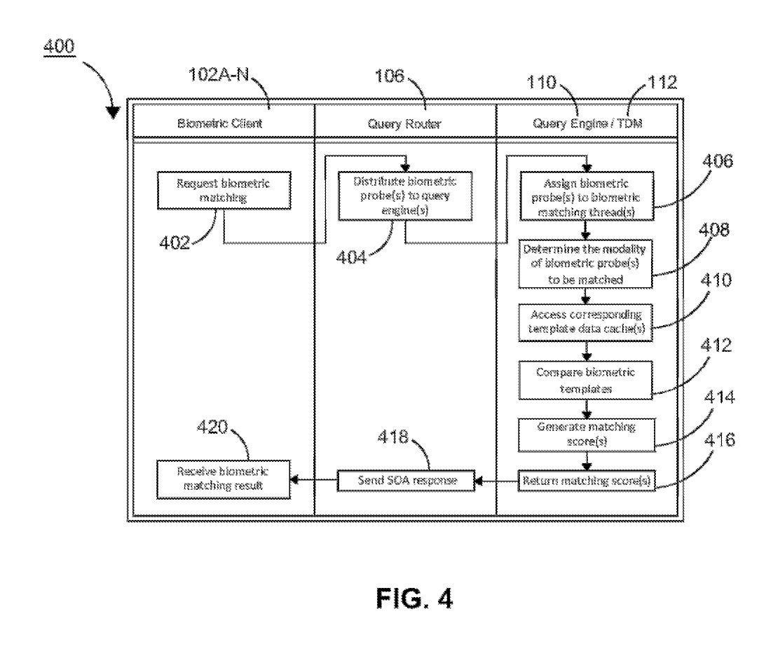

FIG. 4 illustrates a biometric matching process 400 using real-time biometric system 100 according to an embodiment of the invention. The process 400 starts when one or more biometric clients 102A-N request biometric matching of one or more biometric probes in the real-time biometric system 100, at step 402. A biometric client 102 captures one or more biometric probes using biometric input and capture devices. Biometric probe (s) may include images of biometric features such as, but not limited to 2D face, 3D face, hand geometry, single fingerprint, ten finger live scan, iris, palm, full hand, signature, ear, finger vein, retina, DNA and voice, the acquisition and implementation of which are apparent to one of ordinary skill in the art. Subsequently, a biometric client 102 transmits biometric probe(s) to the query router 106, which distributes the biometric probe(s) to one or more corresponding query engines 110A-N depending on the type of biometric modality and work-load of the query engines 110, at step 404.

Continuing the process at step 406, a query engine 110 in conjunction with its TDM 112 assigns the biometric probe(s) to a suitable biometric matching thread. Subsequently at step 408, the query engine 110 in conjunction with its TDM 112 also determines the biometric modality of biometric probe(s) in order to select the appropriate plugins (e.g., fingerprint plugin 208, iris plugin 210, or face plugin 212) and template data caches 114. After biometric modality is determined, the biometric algorithms (fingerprint algorithm 202, iris algorithm 204 or face algorithm 206) convert the biometric probe(s) into corresponding biometric template(s) for comparison against previously stored biometric templates in one or more template data caches 114.

At step 410, the TDM 112 uses one or more memory maps 302 to read one or more biometric templates in primary memory corresponding to one or more biometric templates copied from template data cache 114. That is, the TDM 112 searches for biometric templates directly from primary memory, in real-time, using memory maps 302, and without requiring access to template data cache 114, which is on one or more hard drives or disks. Subsequently, biometric algorithms in the TDM 112 compare converted biometric templates from biometric probes with biometric templates in faster primary memory, at step 412. This biometric template comparison generates a biometric score, at step 414, representing the probability that the captured biometric probe is from the same person as the biometric template it is being compared against. Searching and comparison of biometric templates using memory maps allows for a faster biometric matching process 400.

Continuing the process at step 416, the query engine 110 returns the generated biometric score to query router 106, followed by the sending of a service-oriented architecture (SOA) response, the implementation of which is apparent to one of ordinary skill in the art, from the query router 106 to the biometric client 102, at step 418. Finally, the biometric client 102 receives this SOA response indicating successful or failed biometric matching, at step 420. The return of a biometric score indicating successful or failed matching enhances security of biometric matching process 400 and real-time biometric system 100. That is, biometric templates are not retrieved from template data caches 114, only a biometric score is returned to biometric client 102, thus mitigating the risk of unwanted access to biometric templates.

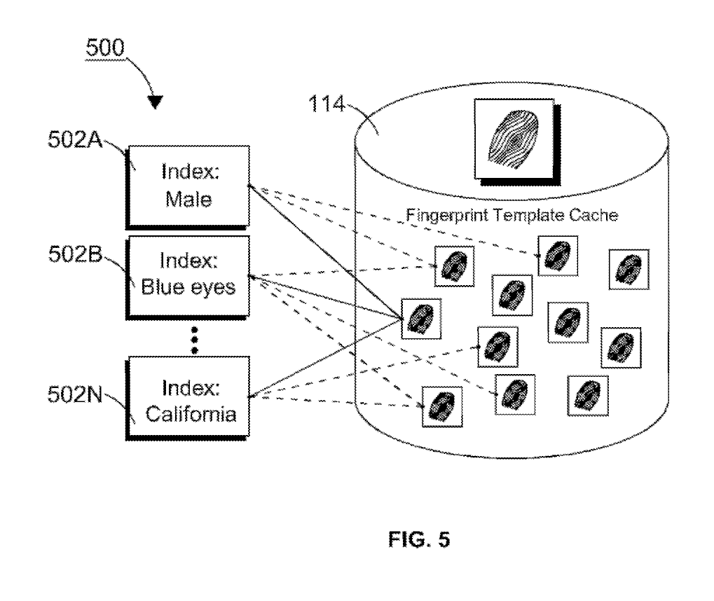

FIG. 5 illustrates a non-biometric metadata implementation 500 in real-time biometric system 100 according to an embodiment of the invention. In the real-time biometric system 100, the template data cache 114 includes any number of indexes 502A-N that use non-biometric metadata associated with biometric templates stored in template data cache 114. For example, the indexes 502A-N may include non-biometric metadata such as male, blue eyes and California. Optionally, these indexes 502A-N with non-biometric metadata are stored as a separate file outside biometric template data cache 114 and associated with the memory maps 302 for fast retrieval and comparison with biometric templates.

In other embodiments of the invention, non-biometric metadata may include physical characteristics such as, but not limited to height, weight, race/color; biographic characteristics such as, but not limited to name(s), birth date, hair color, current location, location of origin, social security number; or any other information not derivable from the stored biometric information.

In the real-time biometric system 100, the TDM 112 uses indexes 502 to search for biometric templates associated with non-biometric metadata. For example, the biometric client 102 sends a request to the real-time biometric system 100 using one or more fingerprint biometric probes. The TDM 112 uses the indexes 502 with non-biometric metadata such as male, blue eyes and California to search for associated biometric templates in template data cache 114 as shown.

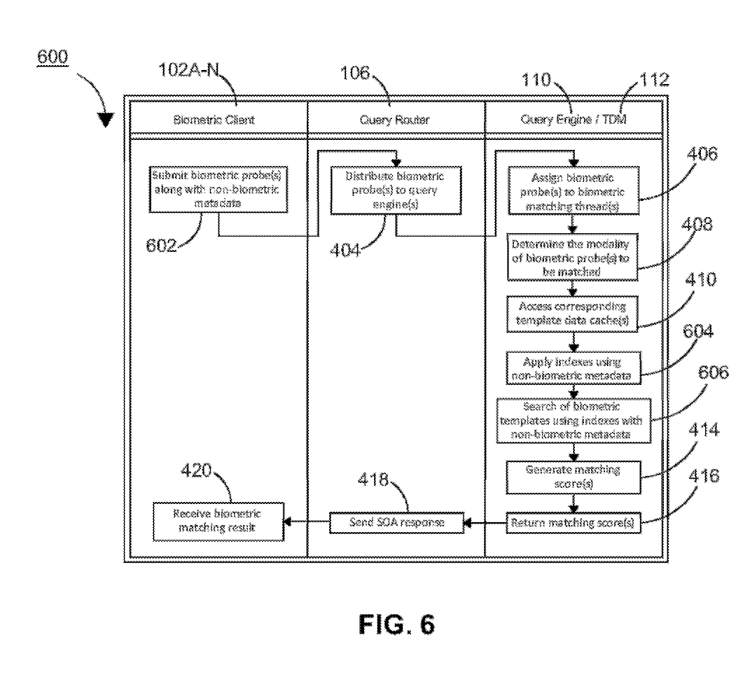

FIG. 6 illustrates a biometric matching process 600 using the non-biometric metadata implementation 500 according to an embodiment of the invention. The process 600 starts when one or more biometric clients 102A-N submit one or more biometric probes along with non-biometric metadata in the real-time biometric system 100, at step 602. Subsequently, the query router 106 distributes the biometric probe(s) to the corresponding query engines 110 depending on the type of biometric modality and work-load of the query engines 110, at step 404.

Following the process at step 406, a query engine 110 in conjunction with its TDM 112 assigns biometric probe(s) to suitable biometric matching threads. Subsequently at step 408, the query engine 110 in conjunction with its TDM 112 may also determine the biometric modality of biometric probe(s) in order to select the appropriate plugins (e.g., fingerprint plugin 208, iris plugin 210, or face plugin 212) and template data caches 114. After biometric modality is determined, the biometric algorithms (fingerprint algorithm 202, iris algorithm 204, or face algorithm 206) convert the biometric probe(s) into corresponding biometric template(s) for comparison against previously stored biometric templates in one or more template data caches 114.

At step 410, the TDM 112 uses one or more memory maps 302 and/or indexes 502 to read one or more biometric templates in primary memory corresponding to one or more biometric templates copied from template data cache 114. That is, the TDM 112 searches for biometric templates directly from primary memory, in real-time, using memory maps 302, and without requiring access to the template data cache 114, which is usually on slower secondary memory. Subsequently, the TDM 112 may apply indexes 502 using non-biometric metadata in real-time biometric system 100, at step 604. These indexes 502 allows the search of biometric templates associated with non-biometric metadata that function as search constraints, at step 606. For example, if the biometric client 102 submits one or more fingerprint biometric probes along with non-biometric metadata such as male, blue eyes and California for the indexing operation, the TDM 112 uses such indexes 502 and this non-biometric metadata to filter only fingerprint biometric templates associated with non-biometric metadata. As such, non-biometric metadata limits the number of filtered biometric templates for biometric matching.

After indexing and searching operation, the query engine(s) 110 generate a biometric score, at step 414, representing the probability that the captured biometric probe is from the same person as the biometric template it is being compared against.

Following the process at step 416, the query engine 110 returns the generated biometric score to query router 106, followed by the sending of a SOA response from the query router 106 to the biometric client 102, at step 418. Finally, the biometric client 102 receives this SOA response indicating successful or failed biometric matching, at step 420.

One of ordinary skill in the art appreciates that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular constraints imposed on the overall system Skilled persons can implement the described functionality in varying ways for each particular system, but such implementation decisions should not be interpreted as causing a departure from the scope of the invention. In addition, the grouping of functions within a unit, module, block, or step is for ease of description. Specific functions or steps can be moved from one unit, module, or block without departing from the invention.

The various illustrative logical blocks, units, steps and modules described in connection with the embodiments disclosed herein, and those provided in the accompanying documents, can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC. Additionally, device, blocks, or modules that are described as coupled may be coupled via intermediary device, blocks, or modules. Similarly, a first device may be described a transmitting data to (or receiving from) a second device when there are intermediary devices that couple the first and second device and also when the first device is unaware of the ultimate destination of the data.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein.

I claim:

1. A biometric system comprising:
a first query engine, the first query engine comprising a template data manager;
a first template data cache in communication with the first query engine, the first template data cache storing a set of biometric templates;
primary memory;
wherein the template data manager copies a subset of the set of biometric templates into the primary memory for comparison against a biometric probe template.

2. The biometric system of claim 1, wherein the first query engine converts a received biometric probe into the biometric probe template.

3. The biometric system of claim 2, further comprising:
a second query engine, the second query engine comprising a template data manager;
a second template data cache in communication with the second query engine; and
a query router for routing the biometric probe to the first query engine.

4. The biometric system of claim 1, further comprising a memory map identifying primary memory addresses of the subset of biometric templates.

5. The biometric system of claim 4, wherein the primary memory is selected from the group consisting of: random access memory, a processor cache, read only memory, and a combination thereof.

6. The biometric system of claim 1, wherein the first query engine comprises a biometric algorithm, wherein the biometric algorithm converts a biometric probe into a biometric probe template.

7. The biometric system of claim 6, wherein the first query engine comprises a plug-in interface.

8. The biometric system of claim 1, wherein the first query engine is configured to compare the subset of biometric templates in primary memory against a biometric probe template and generate a biometric score for each of the subset of biometric templates.

9. A biometric processing system comprising:
primary memory comprising a set of biometric templates;
a memory map identifying primary memory addresses of the set of biometric templates; and
a template data manager configured to search and compare the set of biometric templates against a biometric probe.

10. The biometric processing system of claim 9, wherein said primary memory comprises random access memory.

11. The biometric processing system of claim 9, wherein said primary memory comprises a processor cache or read only memory.

12. A biometric matching method implemented on a processor and comprising the steps of:
copying a set of biometric templates into primary memory from a template data cache;
creating a memory map, wherein the memory map identifies primary memory addresses of the set of biometric templates; and
comparing a biometric probe template against the set of biometric templates.

13. The biometric matching method of claim 12, further comprising the steps of:
receiving a biometric probe, and converting the biometric probe into the biometric probe template.

14. The biometric matching method of claim 12, further comprising the step of generating a biometric score for each biometric template in the set of biometric templates.

15. The biometric matching method of claim 14, further comprising the step of identifying one or more matching biometric templates in the set of biometric templates.

16. The biometric matching method of claim 12, further comprising the step of indexing biometric templates stored in the template data cache according to non-biometric metadata.

17. The biometric matching method of claim 16, further comprising the step of identifying the set of biometric templates based on non-biometric data.

18. The biometric matching method of claim 12, wherein the primary memory is selected from the group consisting of: random access memory, a processor cache, read only memory, and a combination thereof.
